(19) United States
(12) Patent Application Publication
(10) Pub. No.: US 2004/0089713 A1
(43) Pub. Date: May 13, 2004

(54) Employee accounting device and method of operation

(76) Inventor: Eric R. Weaver, Tampa, FL (US)

Correspondence Address: LARSON AND LARSON, 11199 69TH STREET NORTH, LARGO, FL, 33773

(21) Appl. No.: 10/695,974

(22) Filed: Oct. 29, 2003

Related U.S. Application Data
(60) Provisional application No. 60/422,065, filed on Oct. 29, 2002.

(51) Int. Cl. G06K 5/00

(52) U.S. Cl. 235/380

(57) ABSTRACT

An employee accounting device includes an automatic teller machine with time recorder and employee accounting systems utilizing a specialized processor for direct work time accounting and payment. The employee accounting is configured to function for check-in and check-out for a corporation or other similar entity. The employer enters accounting information for payroll deductions and taxes into the specialized processor. The employee time is accounted for and subsequent direct payment is provided in cash from the employee accounting device to the employee. Monies may be transferred and deposited at the employee's discretion through the use of a magnetic card having a unique personal identifier.

### PRIOR APPLICATIONS

This application bases priority on provisional application No. 60/422,065 filed on Oct. 29, 2002.

### BACKGROUND OF THE INVENTION

1. Field of The Invention.

This invention relates to an integrated automated teller machine (“ATM”) providing for employee time and accounting methods. The employee accounting device records employee time worked for an employer and makes direct disbursements for work completed by the employee. More particularly, the invention relates to a system that will record employee work time and process payroll functions for distributing cash directly to employees following supervisor approval from the employer.

2. Background of the Prior Art

U.S. Pat. No. 4,375,032 describes an automated banking system that processes one or more transactions, including cash withdrawal, funds transfer, payments and deposits by accessing the device with an account identification card. A major limiting factor of this prior art reference is the inability to process time-in and time-out functions of employment.

U.S. Pat. No. 4,922,419 discloses a system for performing a desired transaction when a customer follows a specified procedure. This prior art reference terminates operation when the client leaves the ATM allowing no further operation of time accounting between customer visits.

U.S. Pat. No. 4,114,027 describes an automated banking system, which comprises at least one remote transaction and cash dispensing unit interconnected with a central unit via a communication network. This invention provides no interconnection between an employer and employee account to provide for payroll accounting and cash disbursements based upon hours worked.

U.S. Pat. No. 5,313,050 is a cash managing system comprising a plurality of automatic teller machines for receiving and dispensing cash to and from a customer and a cash arrangement device for handling cash in the teller machines. This prior art reference utilizes an ATM for conducting customer transactions. However, it lacks any teaching for recording time-in and time-out for employee work for review by management of an employer.

U.S. Pat. No. 4,812,627 discloses an employee time-keeping system, which has a central data collector device connected to a plurality of remote satellite time clock stations. This prior art reference fails to disclose, let alone suggest or teach accounting and employee payments for work completed on behalf of the employer.

U.S. Pat. No. 5,142,486 discloses an electronic device for monitoring the number of hours worked during a period covering a preselected number of consecutive workdays utilizing a computer to determine the number of hours worked and the number of work hours available to all employees. However, automated components for payment and withdrawal of wages earned are not disclosed or suggested in this reference.

U.S. Pat. No. 5,068,787 discloses a system for analyzing job cost, worker efficiency and the like and includes portable modules for receiving and collecting work time data. However, data calculations and banking institution connections for direct cash payments and withdrawals are not disclosed in this prior art reference.

All of the aforementioned prior art time-keeping and employer accounting devices do not provide for an easy and efficient way to make payroll calculations and employee disbursements in one step. An improved device is needed for networking employer payroll and time-keeping accounts, employee accounts, and a banking institution to provide for immediate and automatic payment for hours worked by an employee.

### SUMMARY OF THE INVENTION

I have invented an employee accounting device utilizing an automated teller machine like those typically found in banking institutions nationally. The employee accounting device tracks the number of hours the employee works and, based upon pre-programmed accounting methods, calculates the appropriate payment. Thereafter, the employee accounting device utilizes a network interface between the banking institution, the employer's account and the employee's account to make a direct payment into the employee's account. The employee can also insert his identification card into the device and process one or more banking transactions, such as, for example, cash withdrawals, funds transfer, electronic payments and deposits.

For the best mode of operation, the employee accounting device is installed at an entrance to an employer's work site. An employee accounting device computer interface allows the employee to check into the work site by inserting his identification card into the device. A network connection between the employee's account, a banking institution and an employer's accounting and payroll systems allows supervisory staff to quickly verify information and authorize direct transfer of the employee's work payments, thereby expediting the payroll process.

### BRIEF DESCRIPTION OF THE DRAWINGS

The invention can be best understood by those having ordinary skill in the art by reference to the following detailed description when considered in conjunction with the accompanying drawings in which:

FIG. 1 shows an employee using an employee accounting device of the present invention; and

FIG. 2 is a flow diagram illustrating the manner in which the employee accounting device of the present invention operates.

### DETAILED DESCRIPTION OF THE PREFERRED EMBODIMENT

Throughout the following detailed description, the same reference numerals refer to the same elements in all the figures.

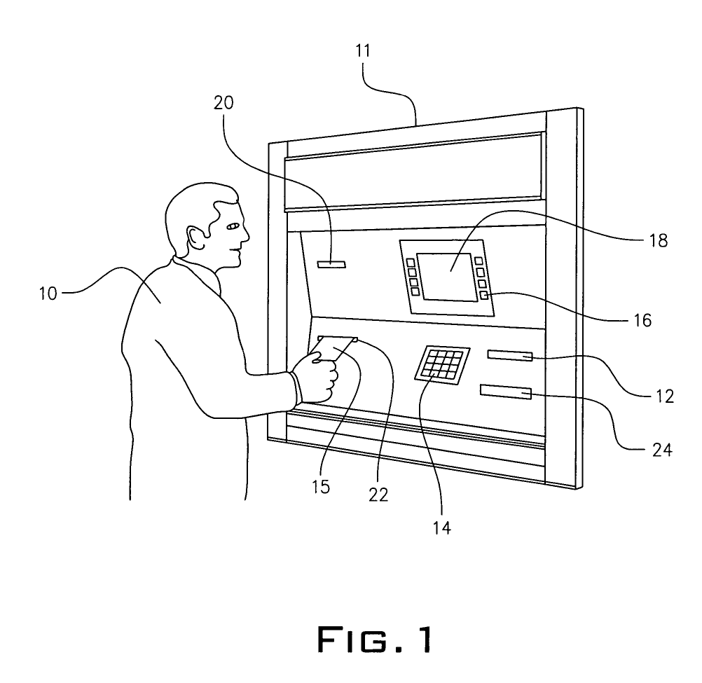

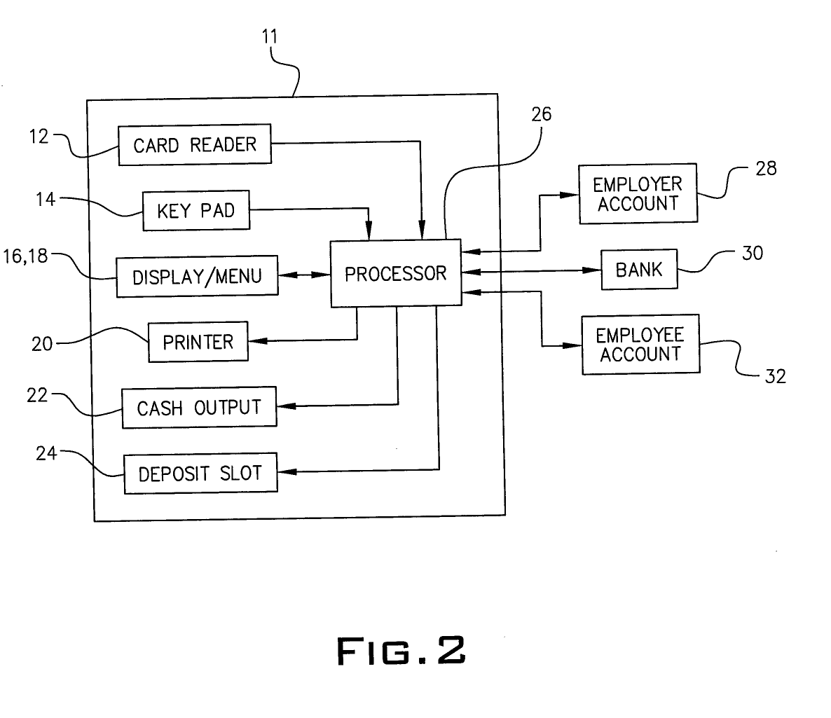

Referring to FIG. 1, an employee 10 inserts a magnetic personalized identification card into a magnetic card reader 12 of an employee accounting device 11 of the present invention. The employee 10 reads instructions on a display screen 18 and thereafter keys in a personal identification number (PIN) to a key pad 14. The transaction type listed on the display screen 18 is selected from a set of menu command buttons 16. If a cash withdrawal is selected, cash money 15 is ejected from a first slot 22 and a transaction receipt is ejected from a second slot 20 for receipt by employee 10. Deposits may be made into a third slot 24. Alternatively, employee 10, when starting the workday, can enter the identification card into slot 12, key in a personal identification number at the key pad 14 and select a begin work check-in option from the menu command buttons 16. At the end of the work day, the employee 10 will enter his identification card into slot 12, key in a personal identification at the key pad 14, and select the end work check-out option from the menu command buttons 16 to make adjustments to an employer account 28 (see FIG. 2) for the days work.

Referring to FIG. 2, a computer network processor 26 coupled to employee accounting device 11 provides a network interface between the employer's account 28, an employee's account 32 and a banking institution 30.

At a predefined employer time, the employer's account 28 will electronically deposit salary funds to the employee's account 32 based upon hours worked and tracked by employee accounting device 11 and standard accounting methods previously agreed upon between employee and employer and which are programmed within device 11.

The present invention provides for easy and efficient means for time accounting and payment to employees for time worked. Employee time accounting and payments are completed using the same automated teller systems network ed to the employers corporation.

In the subject invention, an automated teller machine is employed. It is understood that for the purposes of this invention the automated teller machine can include a plurality of different configurations. For instance, the automated teller machine can be like those typically located outside of banking institutions and shopping establishments wherein a magnetic strip card is used to identify the user. The machine links the identity of the user to an account holding monetary funds (i.e., bank account). Access to the machine permits a user to withdraw funds as well as make deposits into the account. However, other types of automated teller machines can be employed with the present invention. For example, identity of the user could be established through voice recognition, thumb print recognition or retina scan identification. Further, although the automated teller machine of the preferred embodiment of the present invention works as a stand alone banking institution teller machine as well as an employee accounting device, an alternate embodiment of the present invention precludes the device from acting as a stand alone teller machine and requires that the user of the device be an employee of the employer utilizing the device.

Equivalent elements can be substituted for the ones set forth above such that they perform the same function in the same way for achieving the same result.

Having disclosed the invention what is claimed for Letters Patent is:

1. An employee accounting device comprising:
a) an automatic teller machine;
b) a time recording device coupled to the automatic teller machine;
c) a computer network processor for interfacing the automatic teller machine with an employer's time-keeping and payroll accounts, a banking institution, an employer's account and an employee's account.

2. The employee accounting device according to claim 1, wherein an employee's bank records and employment accounting records are accessible through the computer network processor.

3. The employee accounting device according to claim 1, wherein the computer network processor can be accessed by a magnetic identification card having a unique personal identifier.

4. The employee accounting device according to claim 1, further comprising a slot formed on the device into which an employee can insert a personal identification card unique to said employee to check-in and check-out of a work site.

5. The employee accounting device according to claim 1, wherein the device calculates the employee's hours worked.

6. The employee accounting device according to claim 1, wherein the computer network processor includes employer pre-programed salary and tax information for each employee.

7. The employee accounting device according to claim 1, wherein an employer can authorize automatic disbursements from the employer's account to the employee's account based upon the employer pre-programmed salary and tax information.

8. The employee accounting device according to claim 1, wherein an employee can make cash withdrawals of wages earned from an employee's account attributable to said employee.

9. The employee accounting device of claim 1, further comprising a keypad for allowing an employee to enter data.

10. The employee accounting device of claim 9, wherein the data includes an employee unique personal identifier.

11. The employee accounting device of claim 1, further comprising a menu for allowing an employee to choose from a plurality of banking options or a multitude of employment time-keeping options.

12. The employee accounting device of claim 1, wherein the computer network processor compiles a summary of an employee's hours worked for subsequent employer review.

13. The employee accounting device of claim 1, wherein the computer network processor interfaces the time recording device with an employer's pre-programmed salary and tax information thereby calculating an amount for a payment for time worked for the employee.

14. The employee accounting device of claim 1, wherein the computer network processor allows the employer to review and authorize proposed payments to the employee before any funds are transferred.

15. The employee accounting device of claim 1, wherein the device is installed at an employer work site and includes security features to prevent tampering.
